(19) United States
(12) Patent Application Publication
(10) Pub. No.: US 2002/0041994 A1
(43) Pub. Date: Apr. 11, 2002

(54) Metal-containing electrode material at least for secondary elements and method for producing the same

(76) Inventors: Wolfgang Oelerich, Wiesbaden (DE); Thomas Klassen, Hamburg (DE); Volker Guther, Burgthann (DE); Andreas Otto, Rosstal (DE); Rudiger Bormann, Rosengarten (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 09/966,329

(22) Filed: Sep. 26, 2001

Related U.S. Application Data
(63) Continuation-in-part of application No. PCT/DE00/00866, filed on Mar. 22, 2000.

(30) Foreign Application Priority Data
Mar. 26, 1999 (DE) 199 15 142.3

(51) Int. Cl. H01M 10/52; B05D 5/12; H01M 4/62

(52) U.S. Cl. 429/59; 427/126.3

(57) ABSTRACT

In a metalliferous electrode material and a method of making the material, the metalliferous electrode material includes a metal oxide as a catalyst for its hydrogenation and dehydrogenation which metal oxide is intensely mixed with the electrode material by mechanical grinding of the two compounds.

This is a Continuation-In-Part application of international application PCT/DE00/00866 filed Mar. 22, 2000 and claiming the priority of German application No. 199 15 142.3 filed Mar. 26, 1999.

### BACKGROUND OF THE INVENTION

The invention relates to a metal-containing electrode material at least for secondary elements and a method of producing the same.

It is first pointed out that, under the term metal-containing material, atomic metals, metal alloys, intermetallic phases of metals, compound materials as well as corresponding hydrides are to be understood.

It is known that, on the basis of reversible metal hydrides, hydrogen storage devices, so-called hydride storage devices, can be formed. The storage device can be charged while heat is released, that is hydrogen is bound by chemo-sorption and discharged by the application of heat. Hydrogen storage devices can therefore be excellent energy storage devices for mobile and/or stationary applications. They might form in the future a notable storage potential since no noxious emissions are released during the discharge of the hydrogen storage devices.

Very suitable for such hydride storage devices are the so-called nano-crystalline hydrides, which are capable of rapidly storing and releasing the hydrogen. Their manufacture however has been very expensive, so far. Their manufacture, so far, has involved high-energy grinding of elemental components or pre-alloys of nano-crystalline alloys, wherein the grinding procedure can be very long. In a final process step, these nano-crystalline alloys were subjected, depending on the conditions, to a multistage heat treatment under a high hydrogen pressure to be hydrogenated thereby. For many alloys, furthermore, a multiple charging and discharging with hydrogen is necessary to achieve full capacity.

Alternatively, it has been tried to synthesize the respective hydrides by grinding in a hydrogen atmosphere or in a pure chemical way. It has been found, however, that, in this way, the yield of the desired hydrides is smaller and partially additional undesirable phases occur.

Furthermore, certain phases could, or respectively can, not be formed with the known conventional methods.

The German patent application No. 197 58 384.6 discloses a method for the manufacture of nano-crystalline metal hydrides with which the manufacture of stable and meta-stable hydrides or hydrides of meta-stable alloys is possible with a very high yield of up to 100%. The method described in the mentioned German patent application can be performed with easily controllable limiting conditions and with a relatively small energy consumption.

In order for such a hydrogen storage device to rapidly provide the energy stored therein when needed and to permit rapid charging of the hydrogen storage device, it is desirable that the reaction speed during hydrating and dehydrating of metals at low temperatures is kept very high that is a very high reaction speed is to be aimed at.

To this end, so for, the reaction surface has been increased by reducing the size of the particles/crystals of the materials to be hydrogenated or dehydrogenated as far as this was technically feasible. Other means for increasing the reaction speed included the addition of nickel, platinum or palladium.

The disadvantage of the measures known so far for increasing the reaction speed during the hydrogenation and particularly the dehydrogenation, that is, the delivery of the hydrogen from the hydrogen storage is that the available speeds are insufficient for hydrogen storage devices usable for technical applications.

For rechargeable hydrogen-based storage devices, so-called secondary elements or secondary cells, metal hydrides are used as cathode material. During the discharge of electric energy, the respective hydride releases hydrogen and, in this way, converts the respective metal alloy. The hydrogen atom reacts with an OH⁻ ion to form H₂O and an electron. During the charging, a hydrolysis occurs in the electrolyte, wherein an H⁺-and an OH⁻ ion are formed. The H⁺-ion is neutralized by an electron from the charging current and the respective hydrogen is again absorbed by the metal alloy or, respectively, the metal containing electrode material and is stored in the form of a corresponding hydride.

The hydride-based accumulators are utilized for a multitude of applications, among other, as replacement for conventional Ni—Cd batteries.

It can generally be said that the hydride materials for the negative electrode of these rechargeable accumulators have to fulfill the following requirements:

1. They must have a high hydrogen storage capacity. The hydrogen storage capacity is determined by thermodynamics. For the application of such materials as anode materials in a hydride accumulator, a hydride formation enthalpy of 8-10 kcal/mol is optimal. Furthermore, the equilibrium dissociation pressure of the hydride at application temperature should be in the range of between 1 mbar up to several bar. Those criteria are presently fulfilled by alloys, which are based on an inter-metallic compound of the type AB₅, for example, LaNi₅, and alloys which are based on so-called Lasers-phases of the type AB₂ and contain for example N₁Ti.

2. High corrosion resistance with respect to alkaline electrolytes, for example, KOH, as well as a good mechanical stability with respect to repeated charging and discharging procedures in order to guaranty a large number of cycles and therefore a long useful life. The corrosion resistance is attributed to the formation of a passivating film on the surface of the material, which protects the interior of the electrode from corrosion by repeated charging/discharging. The film, however, should not be excessively thick in order not to whilst the diffusion of hydrogen into, and out of, the electrode material. Good hydride materials also should not be changed in their composition during cycling, for example, as a result of dissociation reactions. The mechanical stability of the electrode is determined by the volume change occurring during the absorption/desorption of hydrogen and by the ductility or the strength of the material.

3. High electro-catalytic activity for the electrochemical reduction and oxidation in order to achieve optimal kinetics for the charging and discharging, resulting in a high charging efficiency and a high charging rate capability for the hydride electrode.

4. A high hydrogen diffusion rate into the interior of the storage material in order to avoid a limitation of the charging period because of lead hydride formation kinetics. Furthermore, the ohmic resistance of the electrode material and of all the electric supply lines should be low.

5. Low expenditure for the activation of freshly prepared electrodes.

6. High energy and power density.

7. Low self-discharge rate. The storage electrode should not suffer any capacity losses during an extended storage period. This can be achieved for example by selecting a storage alloy with low plateau pressure and the given application conditions.

8. Low costs for the base materials of the electrode materials and low costs for a method for the manufacture of such electrode materials.

It is generally difficult to fulfill all the above requirements 1 to 8 in a uniform or equal fashion for one particular electrode material. Generally, one particular property is optimized at the expense of the others.

Although the manufacture of metal alloys with a nano-crystalline microstructure which are usable as electrode materials have been successful—see the above-mentioned German patent application No. 197 58 684.6—it has been found that, for large technical applications as electrode material in hydride-based rechargeable batteries, the reaction formation kinetics is still too slow and the achievable power density of such batteries is too low. Furthermore, the mentioned metallic catalysts are too expensive and their use is therefore uneconomical.

It is therefore the object of the present invention to provide a metalliferous material, such as a metal, a metal alloy or an inter-metallic phase, compound materials of metals as well as corresponding hydrides with which, during hydrogenation and dehydrogenation, the reaction speeds are so high, that they are technically feasible for use as energy storage devices or respectively, electrodes at least with secondary elements. A method is to be provided by which the manufacture of a metalliferous material such as a metal, a metal alloy, an inter-metallic phase or a compound material of the materials or corresponding hydrides can be performed in a simple and inexpensive way such that metalliferous materials manufactured in this way can be used commercially in connection with secondary elements for hydrogenation with the technically necessary high reaction speed during hydrogenation and dehydrogenation.

### SUMMARY OF THE INVENTION

In a metalliferous electrode material and a method of making the material, the metalliferous electrode material includes a metal oxide as a catalyst for its hydrogenation and dehydrogenation which metal oxide is intensely mixed with the electrode material by mechanical grinding of the two compounds.

In accordance with the invention, the fact is utilized that, in comparison with pure metals, metal oxides are brittle, hereby a smaller particle size and a homogeneous distribution of the metal oxide in the material according to the invention is achieved. As a result, the reaction kinetics are substantially increased in comparison with metallic catalysts. Another advantage is that the metal oxides are available as catalysts generally at much lower prices than metals or respectively, metal alloys so that also the aim of commercial utilization at reasonable costs for the metalliferous materials according to the invention can be achieved.

Basically, the metal oxide is an oxide of atomic metals such as the oxide of the metals Mg, Al, Si, Ca, Sc, Ti, V, Cr, Mn, Fe, Co, Ni, Cu, Zn, Y, Zr, Nb, Ce, Mo, Sn, La, Hf, Ta, W. In accordance with an advantageous embodiment of the invention, the metal oxide may also consist of mixed oxides of the metals, particularly of the metals listed earlier or of mixtures of the metal oxides.

Advantageously, the metal oxide or metal oxides may be formed by rare earth metals or mixtures of the rare earth metals.

In an advantageous embodiment of the invention, the metal-containing electrode material has a nano-crystalline structure, wherein, equally advantageously, also the catalyst has a nano-crystalline structure. If the metal and/or the catalyst have a nano-crystalline structure, the reaction surface and, consequently, the reaction speed of the hydrogenation or, respectively, the dehydrogenation of the metalliferous material are increased.

The method according to the invention for the manufacture of such a metalliferous electrode material is characterized in that the metalliferous material and/or the catalyst are subjected to a mechanical grinding procedure with the object to form, from both components, a powder with an optimized reaction surface of the metalliferous electrode material as well as to ensure a uniform distribution of the catalyst.

The grinding procedure itself may be selected, depending on the metalliferous material and/or the catalyst, to be differently long so as to achieve the optimal desired reaction surface and an optimal distribution of the catalyst of the metalliferous material according to the invention.

In this connection, it may be advantageous if the metalliferous electrode material as such is first subjected to the grinding and the catalyst is added subsequently to the grinding process, however the process may be reversed, that is, the catalyst may be first subjected to the grinding followed by the metalliferous electrode material. Also, these distinguished possible procedures for the grinding are selected depending on the metalliferous electrode materials and depending on the catalyst to be added.

In order to prevent reactions with the ambient gas during the grinding of the metaliferous electrode material (metal, metal alloy, inter-metallic phase, compound material as well as the hydrides thereof) the method is preferably performed under an inert atmosphere wherein the inert gas is preferably argon.

As already mentioned, the duration of the grinding process for a metalliferous material (metal, metal alloy, inter-metallic phase, compound material as well as the hydrides thereof) and the catalyst is variably selectable depending on the metalliferous electrode material and the selected catalyst. Preferably, the duration of the grinding process is in the area of 1 to 200 hours.

In another type of the method for the manufacture of a metalliferous material, at least for secondary elements, at least one metal oxide is formed on the surface of the electrode material in situ by contact with oxygen from elements of the electrode material or by direct supply of oxygen. In this way, a catalyzing oxide can be formed in situ from elements of the hydride storage material.

Preferably, during performance of the method, the surface of the electrode material is activated chemically and/or mechanically before the oxide is formed, whereby the oxide formation of the metal can be improved.

The invention will now be described in detail with reference to various diagrams, which describe the hydrogenation and dehydrogenation behavior as well as other important parameters.

### BRIEF DESCRIPTION OF THE DRAWING

FIG. 1 an x-ray diffraction diagram after a grinding duration of the metalliferous electrode material of one hour and 200 hours,

FIG. 2a a representation of the sorption behavior of the metalliferous electrode material for the representation of the charging temperature and the charging speed with hydrogen;

FIG. 2b the sorption behavior of the metalliferous electrode material at another temperature depending on the charging time,

FIG. 2c a pressure curve with magnesium-hydrogen for the representation of a maximal hydrogen content of the metalliferous electrode material,

FIG. 3 X-ray diffraction curves showing the catalyst Cr₂O₃ in the hydrogenated as well as in the dehydrogenated state and also traces of MgO and Cr, and

FIGS. 4a-4d a representation of the improvement of the kinetics achieved during the absorption of hydrogen as well as its desorption,

FIG. 5 a typical pattern for the charging capacity during the first 30 charge and discharge cycles of an untreated AB₅ hydride alloy,

FIG. 6 the representation of an activation after the first 5 cycles to show an insufficient activation,

FIG. 7 a corresponding pattern according to FIG. 5 catalyzed however with a metal oxide according to the invention,

FIG. 8 a corresponding pattern according to FIG. 6 catalyzed however with a metal oxide according to the invention,

FIG. 9 a pattern for the discharge capacity achievable with an untreated alloy in the 10. cycle as a function of the discharge currents applied (with respect to lg alloy),

FIG. 10 a representation according to FIG. 9, but in the 30^{th} cycle,

FIG. 11 a corresponding pattern for the same alloy as in FIG. 9, however, catalyzed with a metal oxide according to the invention, and

FIG. 12 a corresponding pattern for the same alloy as in FIG. 10, but catalyzed with a metal oxide according to the invention.

### DESCRIPTION OF PREFERRED EMBODIMENTS

The metalliferous electrode material of the invention may comprise various metals, metal alloys, inter-metallic phases, compound materials and corresponding hydrides. They form the storage material of the hydrogen storage devices according to the invention. To accelerate the hydrogenation or the dehydrogenation metal oxides are added as catalysts to these metalliferous materials, wherein the metal oxide may also be a mixed oxide, that is, it may include several metal oxides. Metal oxides, or, respectively, mixed oxides may consist for example of Mg, Al, Si, Ca, Sc, Ti, V, Cr, Mn, Fe, Co, Ni, Cu, Zn, Y, Zr, Nb, Mo, Sn, Ce, La, Hf, Ta, W or of rare earth. The above listing however is not to be understood in such a way that it represents a limitation of the metal oxides according to the invention to oxides of these metals. Oxides of metals may be for Al₂O₃, SiO₂, TiO₂, V₂O₅, Cr₂O₃, Fe₂O₃, Fe₃O₄, CuO, Nb₂O₅, MoO, MoO₂, etc. The catalyst may also have a nano-crystalline structure.

A method for the manufacture of a metalliferous electrode material according to the invention will be described on the basis of an example. In the description reference is made to the figures.

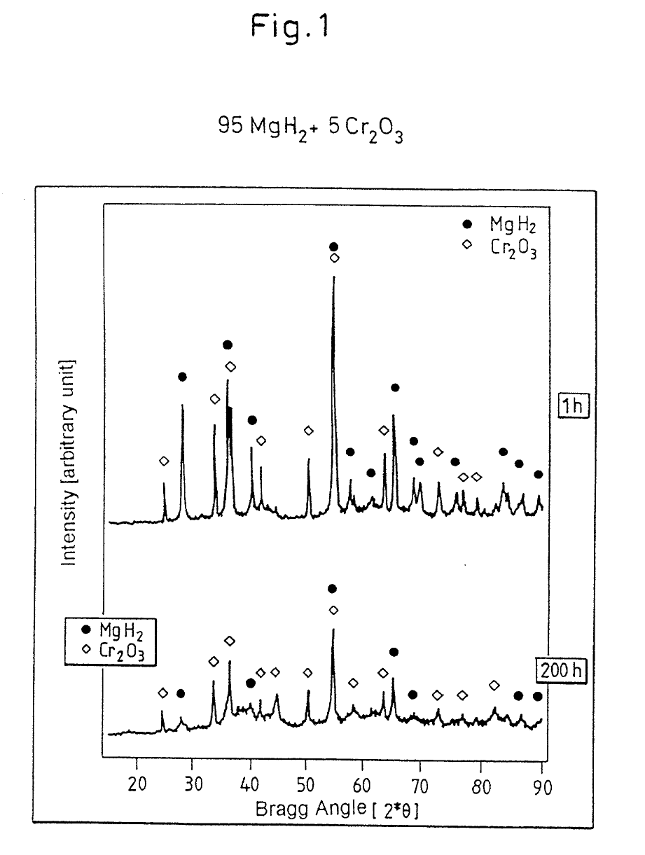

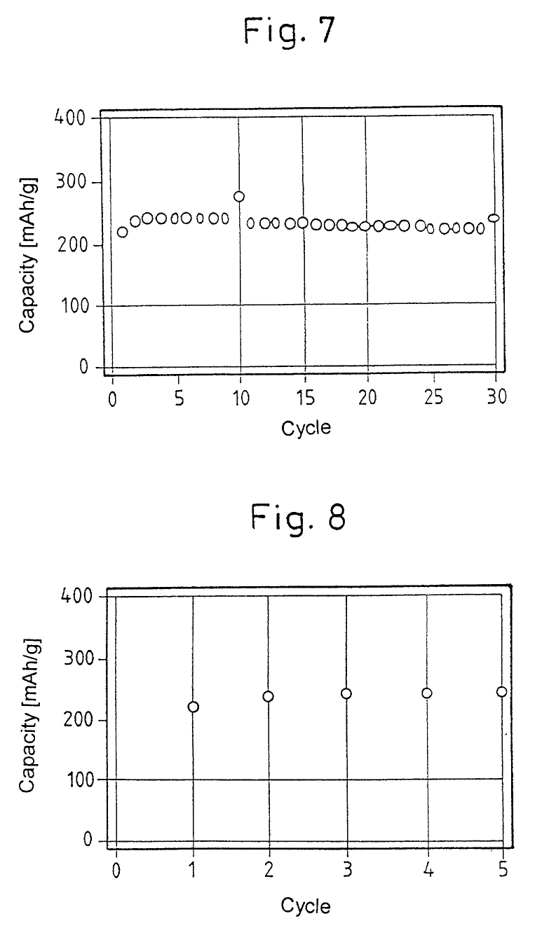

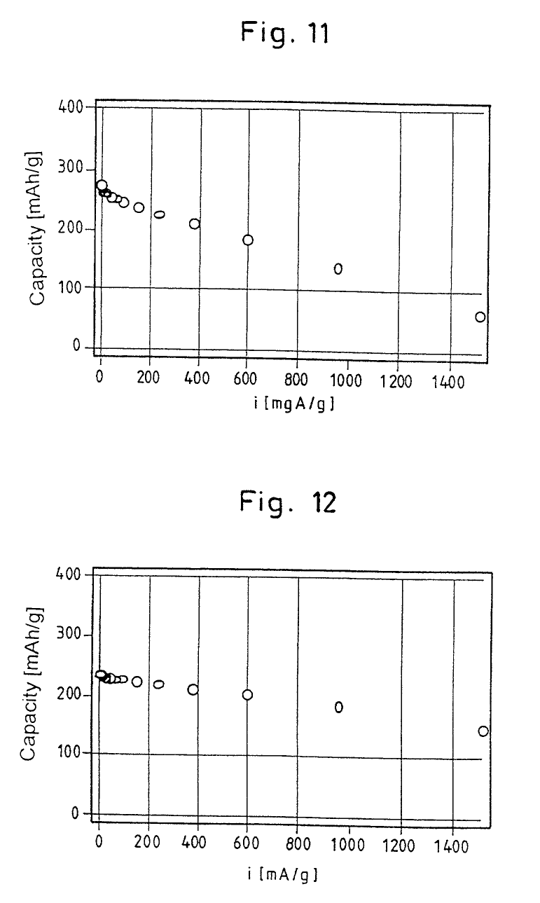

However, before the example is described in detail, it is pointed out generally that a metalliferous electrode material according to the invention (standard-hydride alloy) is pre-ground, for example, to a particle size of 500 μm. The ground material is pre-mixed with a content of 1% to 10% of a metal oxide according to the invention. The mixture is ground in a planetary ball mill for 10 minutes under an argon atmosphere. The power obtained is directly processed to the electrodes, which then have the electrochemical properties shown in FIGS. 7, 8, 11 and 12. With regard to the manufacture of the metalliferous electrode material reference is first made to the FIGS. 1 to 4d.

### EXAMPLE

MgH₂+5Cr₂O₃

Experimental particulars: 30.7 g MgH₂ and 9.3 g Cr₂O₃ were placed into a 250 ml grinding container of steel. 400 g steel balls (ball diameter 10 mm, ratio powder: balls=1:10) were added. The powder was subjected to a mechanical high-energy grinding process in a planetary ball mill of the type “Fritsch Pulverisette 5”. The grinding process was performed under an argon atmosphere for all together 200 hours. During and after the grinding process small amounts of powder were removed for an X-ray structure analysis. FIG. 1 shows the x-ray diffraction diagrams after a grinding duration of 1 hr and 200 hrs. In addition to the MgH₂ also the Cr₂O₃ is detectable after 200 hrs by x-ray structure analysis.

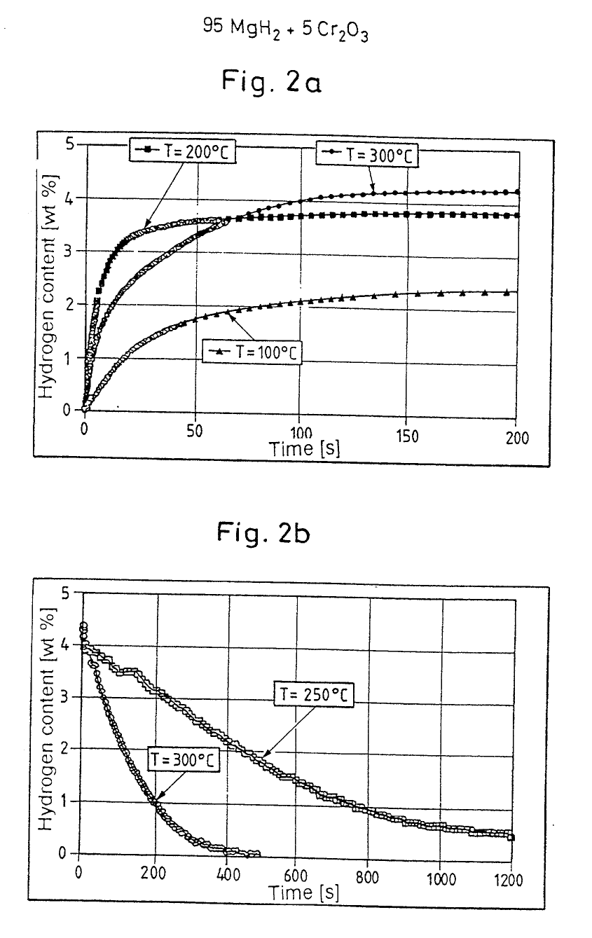

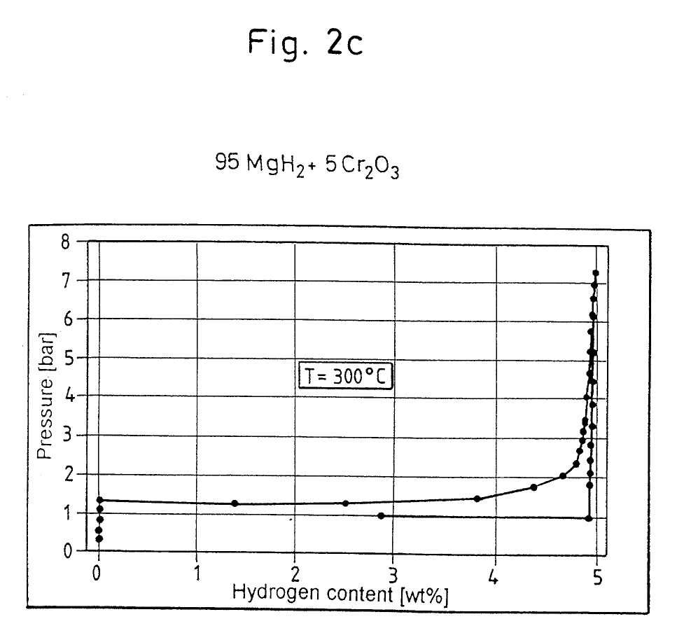

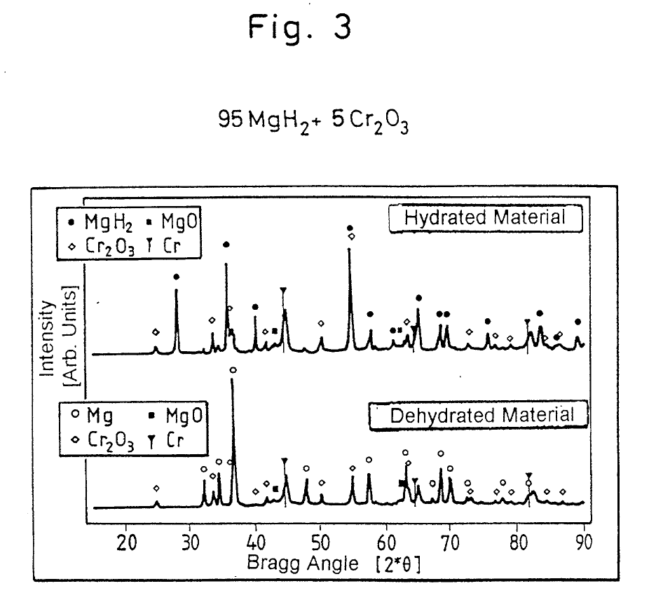

Sorption Behavior: In accordance with FIG. 1, the material can be charged at a temperature of 300° C. in 100 sec with 4 wt % hydrogen. At a temperature T=250° C., a hydrogen content of about 3.6 wt % is reached already after about 50 sec. Also, at T=100° C., a rapid charging is possible. A complete hydrogen discharge is possible at T=300° C. in about 400 sec. At T=250° C., however, in 1200 sec (see FIG. 2b). In the PCT diagram (FIG. 2c), a maximal hydrogen content of the material of 5 wt % is shown in addition to the pressure level of 1.6 bar, which can be assigned to the system magnesium-hydrogen. FIG. 3 shows x-ray diffraction pictures in which, in addition, to Cr₂O₃, traces of MgO and eventually Cr as inactive phase are shown in the hydrogenated as well as in the dehydrogenated state. Furthermore, MgH₂ can be found in the hydrogenated and Mg can be found in the dehydrogenated state.

Comparison of Magnesium+Chromium Oxide with Pure Magnesium:

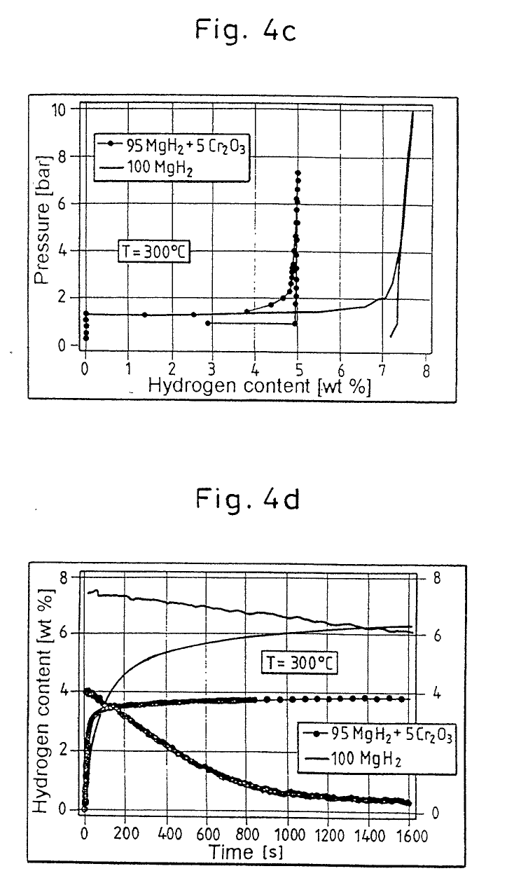

In accordance with FIGS. 4a-4d a clear improvement of the kinetics during absorption of hydrogen as well as during its desorption is apparent. The samples subjected to the same grinding process have different total capacities of hydrogen. 95 MgH₂+5 Cr₂O₃ can store 5 wt % and 100 MgG₂ can store 7.6 wt % hydrogen. This is shown in the PCT diagrams (FIG. 4c). FIG. 4a shows an increase of the absorption speed at T=300° C. by the factor 10 . During desorption at the same temperature a speed advantage with a factor of 6 is achieved (FIG. 4b). The material can be fully dehydrogenated at T=250° C. in about 1200 sec, if the catalyst Cr₂O₃ is added (FIG. 4d). Pure MgH₂ cannot be dehydrogenated at T=250° C. within a reasonable period.

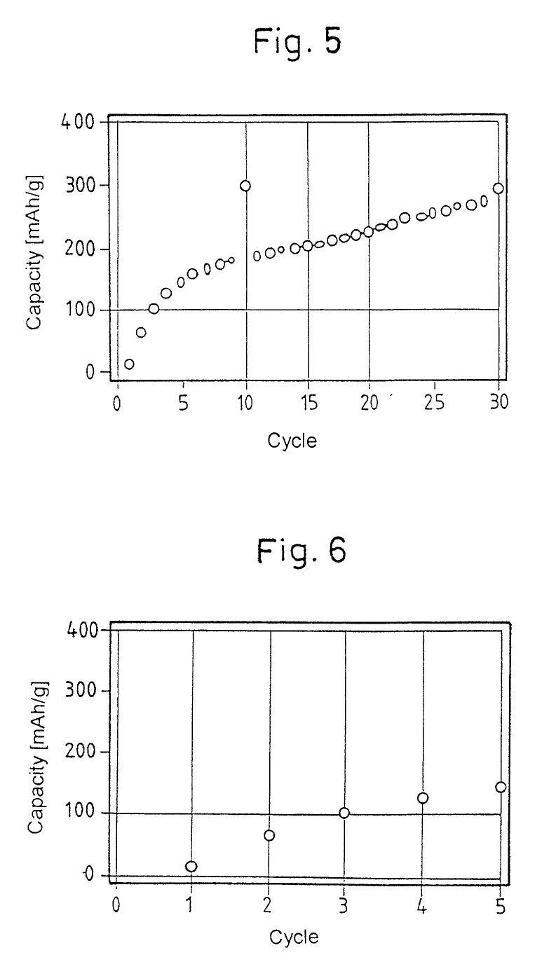

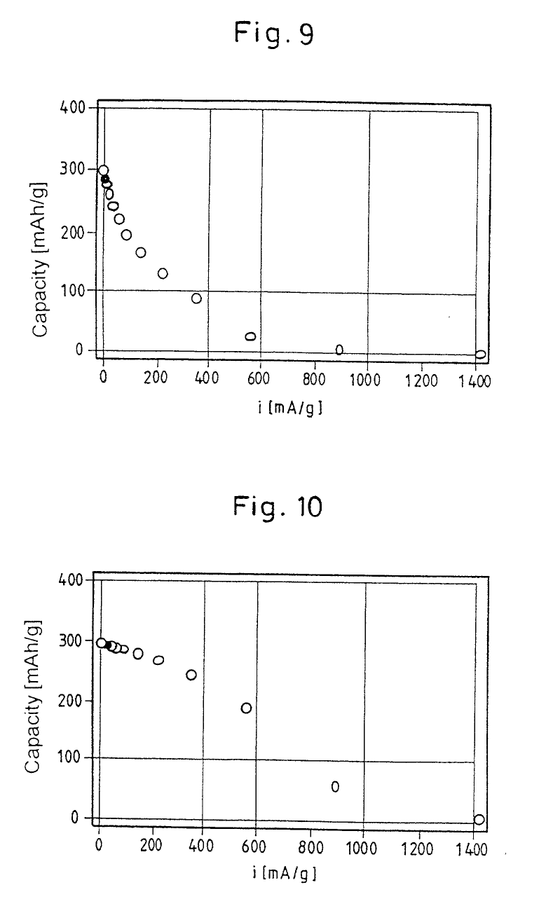

With reference to FIGS. 5 to 12, it is apparent that the acceleration obtainable in accordance with the invention for storing the hydrogen and for the release from the storage material of the electrode (anode) of the accumulator as well as the manufacturing method according to the invention substantially increases the power density and the current density of the accumulator by use of the electrode material, which has been catalyzed in accordance with the invention in comparison with conventional accumulators. As a result, the accumulators according to the invention are suitable for high power applications, for which, so far, only Ni—Cad elements or cells could be used (see also the above requirement criterion 6. Furthermore, storage materials can be used for the electrode whose equilibrium pressure is lower at the application conditions and which form more stable hydrides than those that have been common so far. As a result, lower self-discharge rates are achieved, see the above requirement criterion 6. The acceleration of the kinetics achieved by the catalysts according to the invention compensates for the loss in thermodynamic drive force toward a hydrogenation/dehydrogenation of the electrode material, so that, in spite of the greater stability of the hydride, current densities are achieved which are sufficient for the application. The oxide catalyst according to the invention or, respectively, the catalyst additions can be manufactured or provided at substantially lower costs than the metals used so far, see above requirement criterion 8. The activation procedure for the electrode material used so far is eliminated with the manufacture of the metalliferous electrode material according to the invention (see criterion 5).

It is apparent from FIGS. 5 to 12 that the charging and discharging behavior of the electrode material according to the invention provides for extraordinarily large advantages and improvements when compared with the corresponding behavior of the conventional electrode materials.

It is basically possible to use the electrode material according to the invention also for electrodes of non-rechargeable primary elements or cells, which however could be regenerated.

What is claimed is:

1. A metalliferous electrode material at least for secondary elements, wherein the metalliferous electrode material includes at least one metal oxide as catalyst for the hydrogenation or dehydrogenation.

2. A metalliferous electrode material according to claim 1, wherein the metal oxide is a mixed oxide.

3. A metalliferous electrode material according to claim 1, wherein the metal of one or both of the metal oxide is a rare earth metal.

4. A metalliferous electrode material according to claim 1, wherein the metal has a nanocrystalline structure.

5. A metalliferous electrode material according to claim 1, wherein the catalyst has a nano-crystalline structure.

6. A method of producing a metalliferous electrode material at least for secondary elements comprising the steps of subjecting the metalliferous material, and a catalyst to a mechanical grinding process.

8. A method according to claim 6, wherein the metalliferous material is first subjected to said grinding process and the catalyst is subsequently added to the grinding process.

9. A method according to claim 6, wherein the catalyst is first subjected to the grinding process and the metalliferous material is subsequently added to the grinding process.

10. A method according to claim 6, wherein the grinding process is performed in a protective inert gas atmosphere.

11. A method according to claim 10, wherein the inert gas is argon.

12. A method according claim 6, wherein the duration of the grinding process is in the range of 1 to 200 hours.

13. A method of manufacturing a metalliferous electrode material usable as an electrode material at least for secondary elements, comprising the step of forming at least one metal oxide at least on the surface of the electrode material in situ by contact with oxygen from elements of the electrode material or by direct oxygen admission.

14. A method according to claim 13, wherein the surface of said electrode material is chemically activated before being exposed to the oxygen for forming the oxide.

15. A method according to claim 13, wherein the surface of the electrode material is mechanically activated before it is exposed to the oxygen to form the oxide.
